(19) United States
(12) Patent Application Publication
(10) Pub. No.: US 2006/0218088 A1
(43) Pub. Date: Sep. 28, 2006

(54) Intelligent auto-fill transaction data

(76) Inventors: John Reed Flora, Pleasanton, CA (US); Matthew James Homier, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/389,342

(22) Filed: Mar. 24, 2006

Related U.S. Application Data
(60) Provisional application No. 60/665,430, filed on Mar. 24, 2005.

(51) Int. Cl. G06Q 40/00

(52) U.S. Cl. 705/39

(57) ABSTRACT

A menu of candidate entries for a category field of a transaction is presented. A best candidate is identified based on partial user input in a category field and on additional descriptive information about the transaction, such as whether it is an expense transaction or an income transaction. The category field is tentatively populated according to the identification of best candidate. The user can accept the suggested entry, or override it.

### CROSS-REFERENCE TO RELATED PATENT APPLICATIONS

The present invention claims priority from U.S. Provisional Patent Application Ser. No. 60/665,430 (Attorney Docket Number 9402), for CATEGORIZATION MANAGEMENT, filed Mar. 24, 2005, the disclosure of which is incorporated herein by reference.

### BACKGROUND

The present invention relates to entry of transaction data in a personal financial software package.

Conventional financial software applications have auto-fill functionality that sometimes requires users to make unnecessary key strokes or mouse clicks.

Auto-fill is a well-known time-saving device for data entry. When entering a data item into an input field of a software application, a user need only type in the first few characters of the data item. Once the software application recognizes the data item being entered (by matching it against a predetermined list of data items), the software application completes the entry automatically by entering the remaining characters. Generally, the user is given an opportunity to either accept the software application's suggestion (for example, by hitting a tab key or enter key), or override the suggestion (for example, by continuing to type).

Such a technique can be used, for example, when entering a category for a financial transaction. A predefined list of categories exists; therefore, as the user types a category name, the software application can compare the entered characters against the categories in the list. Once a unique match is detected, the software application automatically fills in the rest of the category field. Again, the user can accept or override the suggestion.

In some software applications, auto-fill is performed only when a single match exists for the entered characters. In other applications, auto-fill is performed even when more than one possible match exists. For example, the software application may guess as to the most likely match and may automatically fill in the field accordingly. If, as the user continues to type, this best guess changes, the software application replaces the previously auto-filled text with revised auto-filled text.

Category names are often similar to one another. In many situations, the first few characters of a category name are identical to the first few characters of another category name. Thus, the software application is unable to determine which category is intended until the user has already typed all of the characters that are identical between the two category names. In many situations, this is cumbersome and inconvenient, because it requires the user to type in several characters before the auto-fill functionality takes effect.

For example, if a first category is “Gift” and a second category is “Gift Received”, the software application cannot determine which category is intended until the user has typed in at least five or six characters: “Gift” (including a space as the fifth character), or in some cases “Gift R” (including the first letter of the word “Received”). Until that point is reached, the software application either does not perform any auto-fill, or it makes a guess as to which category is intended (and the guess may or may not be correct). Thus, in many situations, the user is required to enter at least five or six characters before the correct auto-fill entry is made.

### SUMMARY

The present invention provides techniques for performing auto-fill more quickly and with fewer keystrokes than prior art methods. According to the techniques of the present invention, an intelligent determination is made as to which category, payee, or other data item is intended, even when a user-entered character string matches more than one item.

The present invention can be implemented in either a personal financial software package or an accounting software package. It can be implemented as a feature of a software package, or as a feature of a web-based application or website, or as a plug-in that can be installed and used in connection with an existing software application.

In one aspect, the present invention provides improved functionality in selecting categories and entering data.

According to the techniques of the present invention, the software application takes into account additional available information, aside from the user-entered keystrokes in the category entry field, to more accurately determine which category (or other data item) the user is attempting to enter. For example, the software application may take into account the type of transaction (income or expense), and select a likely match based on a combination of the transaction type and the user-entered characters.

Thus, if a “Gift” category is generally associated with expenses and a “Gift Received” category is generally associated with income, the software application of the present invention auto-fills with “Gift” if it detects that the user is entering an expense transaction, but auto-fills with “Gift Received” if it detects that the user is entering an income transaction. The appropriate auto-fill operation can thereby be selected and executed before the user has entered sufficient characters to uniquely identify a category.

In one aspect, a drop-down menu of categories is shown. A category that matches the entered characters is highlighted. If more than one category matches the entered characters, additional information (such as transaction type) is used to determine which category is the best candidate entry; that best candidate entry is highlighted in the menu.

In another aspect, the drop-down menu contains categories that start with the string of characters the user has entered in the category field. The listed categories are sorted according to type, with the first group of categories corresponding to the type of the transaction. For example, if an expense transaction is being entered, expense categories are listed first in the drop-down menu, followed by other types of categories.

As the user continues to enter characters, the entries in the drop-down menu are adjusted accordingly.

In another aspect, the entry field is tentatively populated with the best candidate entry. This can be done independently of or in combination with menu display.

### BRIEF DESCRIPTION OF THE DRAWINGS

The accompanying drawings illustrate several embodiments of the invention and, together with the description, serve to explain the principles of the invention.

FIGS. 1A, 1B, and 1C, depict an example of auto-fill functionality according to one embodiment of the present invention.

FIG. 1D depicts an example of a dialog box prompting a user for confirmation of a newly entered category according to one embodiment of the present invention.

FIGS. 2A and 2B depict an example of auto-fill functionality according to another embodiment of the present invention.

FIG. 3 is a block diagram depicting a system architecture for an implementation of the present invention according to one embodiment.

FIG. 4 is a flowchart depicting a method for an implementation of the present invention according to one embodiment.

One skilled in the art will recognize that these Figures are examples of the operation of the invention according to one embodiment, and that other user interface arrangements and modes of operation can be used without departing from the essential characteristics of the invention. In particular, the screen shots and user interface elements shown in the Figures are exemplary; other layouts, arrangements, formats, and user interface features may be provided without departing from the essential characteristics of the present invention.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

For illustrative purposes, the invention is described in connection with entry of category information for transactions in a personal financial software package or accounting package. Various specific details are set forth herein and in the Figures, to aid in understanding the present invention. However, such specific details are intended to be illustrative, and are not intended to restrict in any way the scope of the present invention as claimed herein. In particular, one skilled in the art will recognize that the invention can be used in connection with category names, payee names, payer names, or any other elements of financial transactions. References herein to “categories” should thus be taken as exemplary, and are not intended to limit the invention to that particular transaction component. In addition, the particular screen layouts, appearance, and terminology as depicted and described herein, are intended to be illustrative and exemplary, and in no way limit the scope of the invention as claimed.

Output generated by the invention can be displayed on a screen, transmitted to a remote device, stored in a database or other storage mechanism, or used in any other way. In addition, in some embodiments, the invention makes use of input provided to the computer system via input devices such as a keyboard, mouse, touchpad, or the like. Such hardware components, including their operation and interactions with one another and with a central processing unit of the computer, are well known in the art of computer systems and therefore are not depicted here.

Overview

In one embodiment, when a user enters a new transaction, he or she may select a category for the transaction by typing in the first few characters of the desired category. A drop-down menu is presented that includes a list of categories. One category (or in other embodiments, more than one category), that at least partially matches the entered characters, is highlighted in the menu. If more than one category at least partially matches the entered characters, then a determination is made as to which category is the “best candidate category”. This determination is made based on additional information about the transaction, such as transaction type (income or expense), amount paid, transaction number, payor identifying information (name, unique numerical identification), heuristic determination (based upon past spending habits, payors, or other factors tending to show patterns of category usage), product customization, or any information providing context to a particular transaction.

The best candidate category is highlighted in the menu.

In alternative embodiments, other mechanisms for indicating the best candidate category are used, as will be described in more detail below.

### EXAMPLES AND DETAILED DESCRIPTION

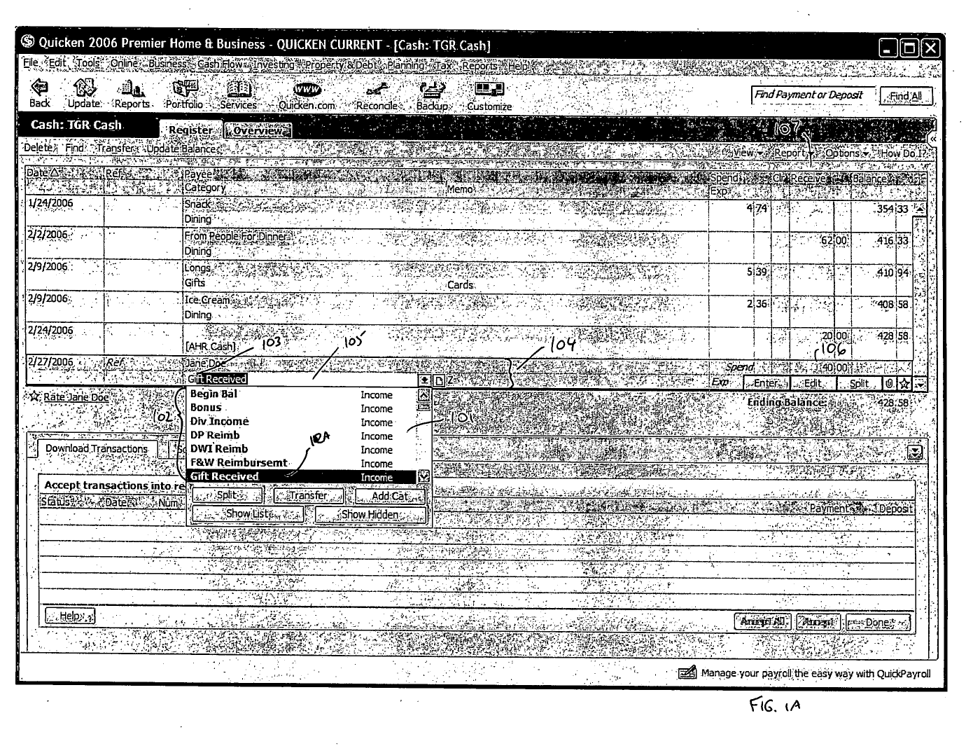

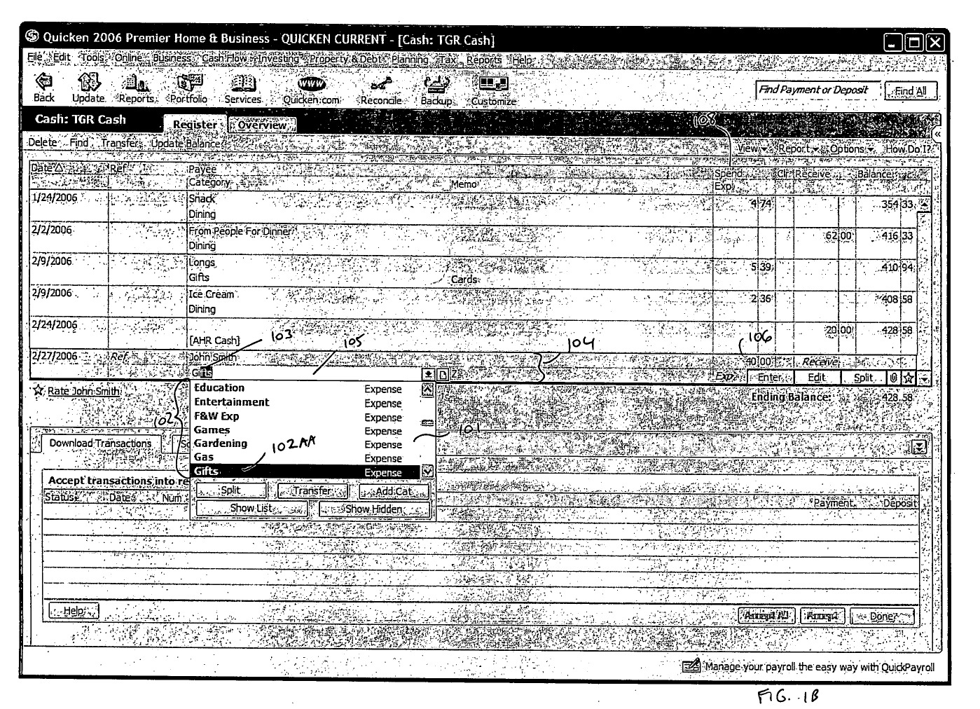

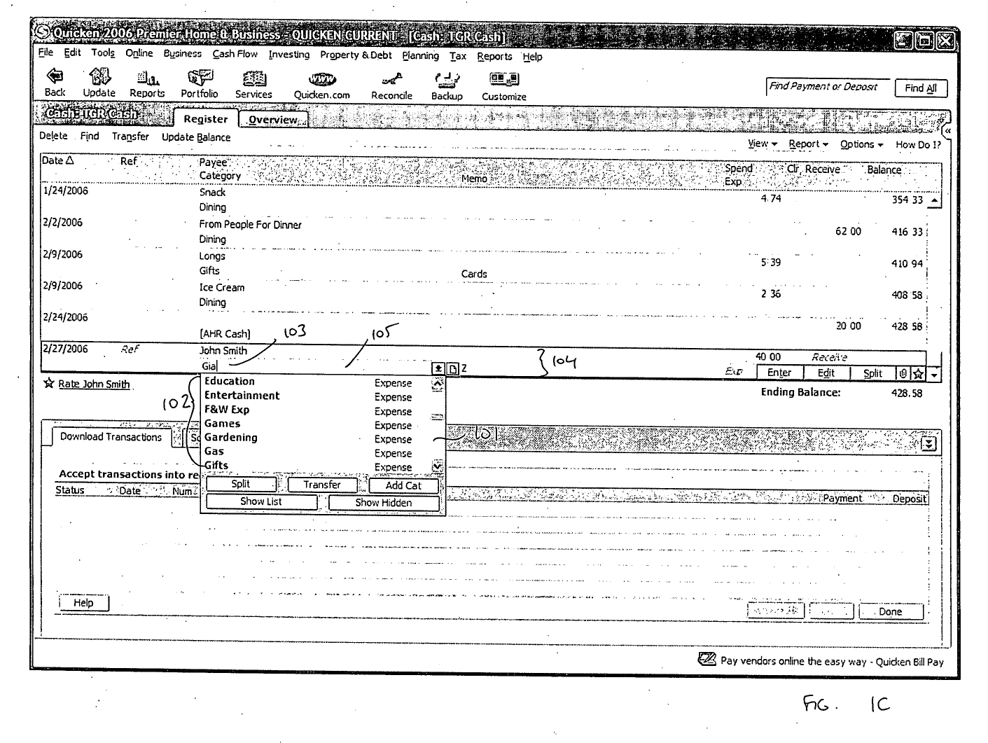

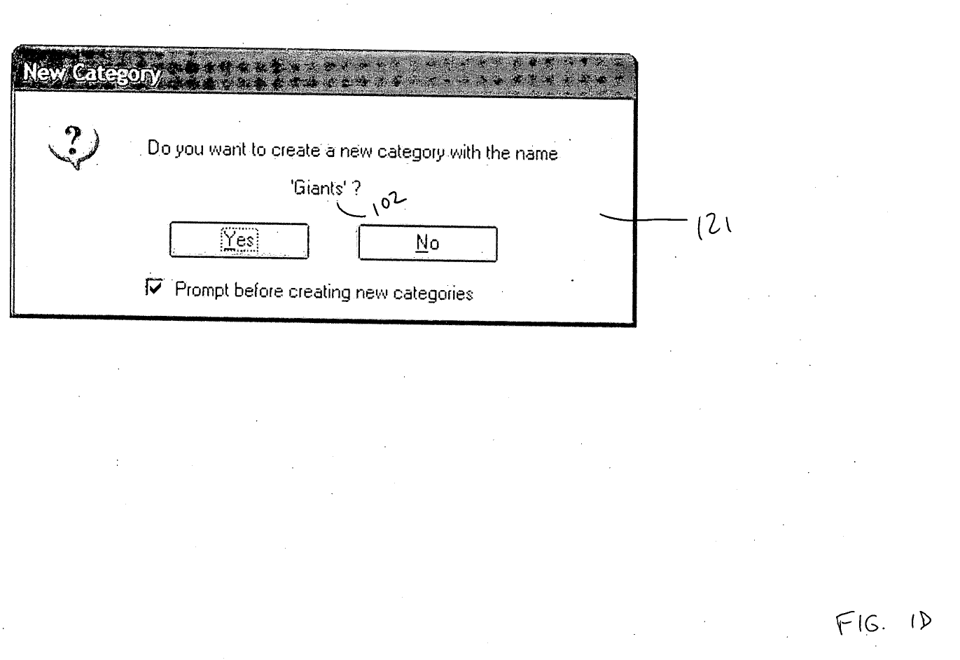

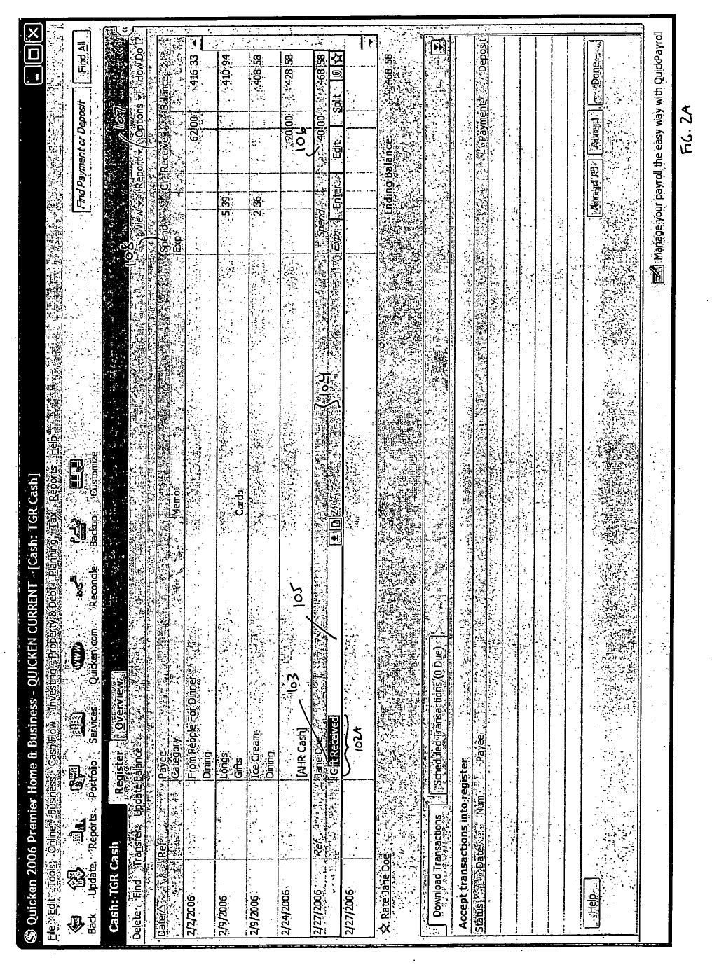

In one embodiment, as shown in the example of FIG. 1A, a drop-down menu 101 appears, containing categories 102 from a predefined list. Here, the user has entered two characters, “Gi” 103, in entry field 105 for transaction 104. The user has already specified that this is an income transaction by entering the amount 106 of $40.00 in “Receive” column 107.

A best candidate category 102A is highlighted. In one embodiment, it is presented in inverse video; in another it is presented in a different typeface, or in boldface, or in a different color. Any other technique can be used for highlighting the best candidate category 102A. In one embodiment, the best candidate category is also presented in the entry field 105 itself. If more than one category 102 in the list match the entered characters “Gi” 103, the system of the present invention makes a determination as to which category 102 is the best candidate. Matching categories 102 that belong to the same transaction type as the current transaction 104 are given precedence, so as to increase the likelihood that the correct (intended) category 102 is highlighted. For example, as shown in FIG. 1A, since the user is entering an income transaction (as indicated by the fact that he or she has entered amount 106 in “Receive” column 107), the “Gift Received” category 102A is highlighted rather than a “Gifts” category. Assuming no other income categories 102 start with “gi”, the user can correctly identify the intended category 102 by hitting Enter or Tab after entering only the first two characters of the category 102.

At any time, the user can press a key (such as Enter or Tab) to select the highlighted category 102A in drop-down menu 101. If the user wishes, he or she can continue typing. If the continued typing changes the best candidate category 102A, the new best candidate is highlighted.

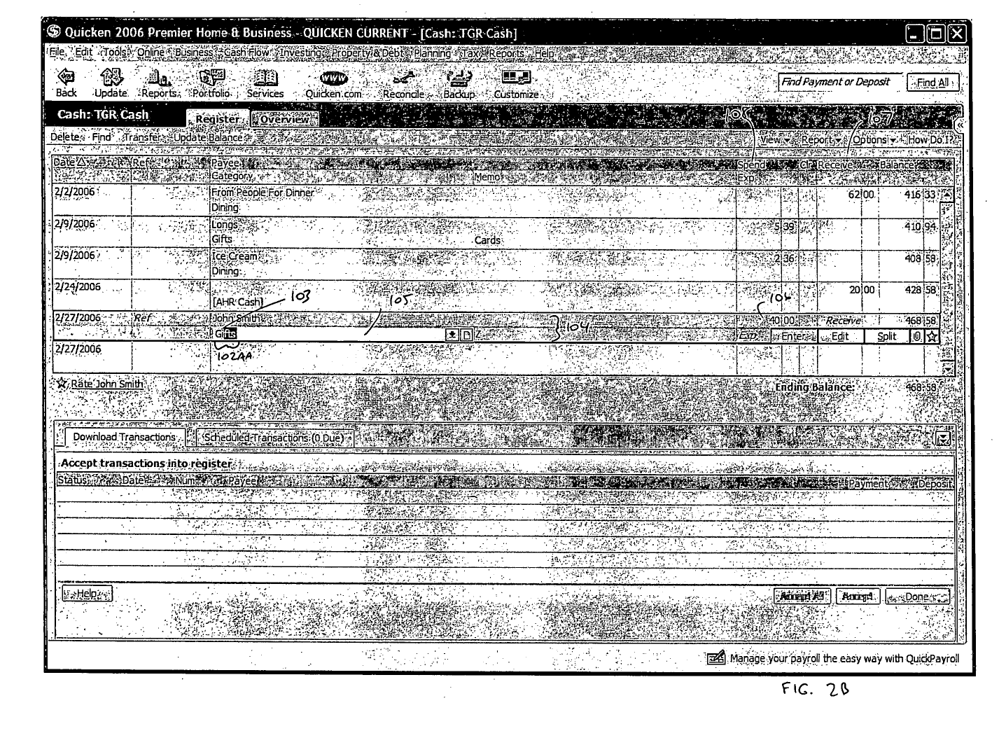

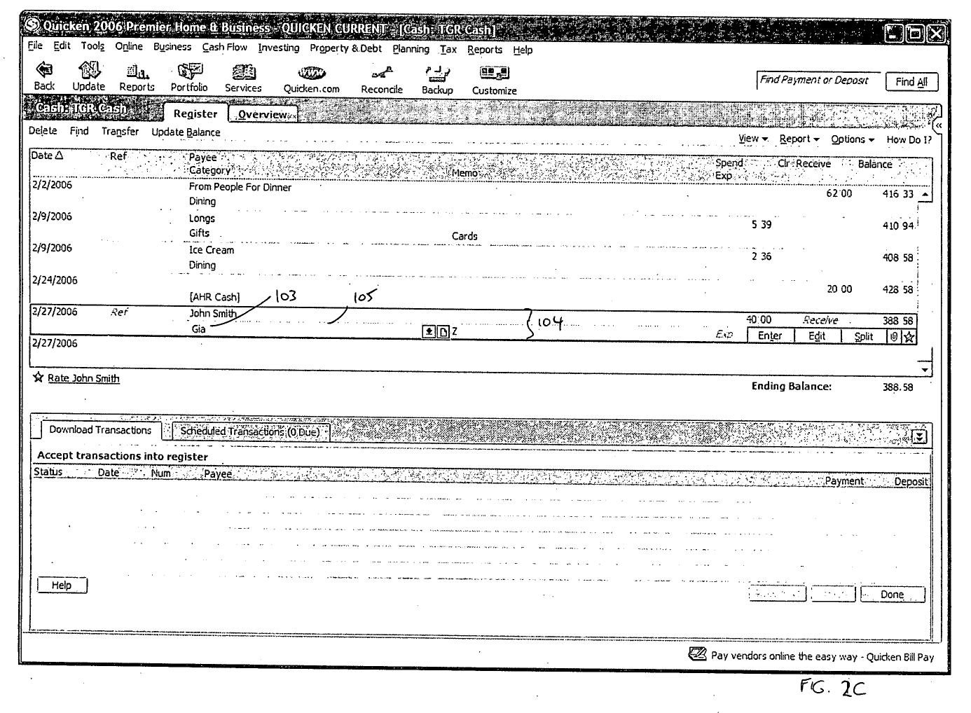

If the continued typing causes there to be categories 102 that match the user-entered input, as shown in FIG. 1C, in one embodiment drop-down menu 101 is still shown but no category 102 is highlighted. In another embodiment, if the continued typing causes there to be no match among categories 102, as shown in FIG. 2C, drop-down menu 101 is dismissed and entry field 105 becomes a simple text entry box.

In one embodiment, if the user indicates that he or she is finished with entry of a category 102 that does not match any category in the list, the user is prompted to confirm that he or she wishes to enter a category 102 that did not previously exist. Referring now to FIG. 1D, there is shown an example of a dialog box 121 containing such a prompt.

In one embodiment, if the user deletes previously-entered characters 103 (for example by backspacing), or otherwise edits his/her input, the system of the invention returns to a previous step corresponding to the characters remaining after the deletion or edit.

In one embodiment, once drop-down menu 101 is presented, the user can select a non-highlighted category 102 from drop-down menu 101 by pointing and clicking or by using keyboard commands. The selected category 102 is then highlighted and entry field 105 is populated accordingly.

Referring now to FIG. 1B, there is shown an example where the user has indicated an expense transaction 104 by entering amount 106 in “Spend” column 108. Here, “Gifts” category 102AA is highlighted rather than the “Gift Received” category 102A, even though “Gift Received” precedes “Gifts” when sorted alphabetically. Assuming no other expense categories start with “gi”, the user can correctly identify the intended category 102 by hitting Enter or Tab after entering only the first two characters of the category.

Accordingly, in one embodiment, the present invention takes into account category type (income or expense) when determining which category 102 to highlight in category drop-down menu 101. The determination as to whether a transaction is an income transaction or expense transaction can be made based on any available information, including but not limited to: user input as to which column 107, 108 the transaction amount 106 was entered in; information previously stored in the transaction record (for example for downloaded transactions); and previously determined associations between payee name and transaction type (for example for memorized or previous similar transactions). As indicated below, other information besides transaction type can also be used in determining the best candidate category 102 for the transaction.

In another embodiment, as shown in the example of FIG. 2A, no drop-down menu appears. Rather, the best candidate category 102 from the predefined list is presented in entry field 105 itself, based on user-entered characters 103 and on other available information. A best candidate category 102A is displayed in entry field 105. If more than one category 102 in the list (not shown) match the entered character, the system of the present invention makes a determination as to which category 102 is the best candidate. As described above, matching categories 102 that belong to the same transaction type as the current transaction are given precedence, so as to increase the likelihood that the correct (intended) category 102 is shown. For example, if the user is entering an income transaction (as indicated by the fact that he or she has entered amount 106 in “Receive” column 107), the “Gift Received” category 102A is presented rather than the “Gifts” category. Assuming no other income categories start with “gi”, the user can correctly identify the intended category 102 by hitting Enter or Tab after entering only the first two characters 103 of the category 102.

At any time, the user can press a key (such as Enter or Tab) to select the category 102 presented in entry field 105. If the user wishes, he or she can continue typing. If the continued typing changes the best candidate category 102, the new best candidate category 102 is presented. If the continued typing causes there to be no likely candidate categories 102, entry field 105 becomes a simple text entry box, as shown in FIG. 2C. In one embodiment, the user is prompted, as shown in FIG. 1D, to confirm that he or she wishes to enter a category 102 that did not previously exist. In one embodiment, if the user deletes previously-entered characters 103 (for example by backspacing), or otherwise edits his/her input, the system of the invention returns to a previous step corresponding to the characters remaining after the deletion or edit.

Referring now to FIG. 2B, there is shown an example where the user has indicated an expense transaction 104 by entering amount 106 in “Spend” column 108. Here, “Gifts” category 102AA is presented rather than the “Gift Received” category 102A, even though “Gift Received” precedes “Gifts” when sorted alphabetically. Assuming no other expense categories 102 start with “gi” the user can correctly identify the intended category 102 by hitting Enter or Tab after entering only the first two characters of the category.

In other embodiments, a drop-down menu appears, containing only those categories 102 from the predefined list that match the entered characters 103. A best candidate category 102 is highlighted. If more than one category 102 in the list matches the entered characters 103, the system of the present invention makes a determination as to which category 102 is the best candidate according to the techniques described above. Other candidate categories 102 are shown, for example below the highlighted candidate category 102. Additional text entry causes the menu to be updated to only show those categories 102 that match the entered characters 103. If the user's input in entry field 105 does not match any categories 102 in the list, the menu is dismissed and the entry field 105 becomes a simple text entry field.

As described above, the user can select other categories 102 within the drop-down menu (while the menu is displayed) by pointing and clicking or by using keyboard commands.

In one embodiment, the best candidate category 102 is highlighted and shown at the top of the menu. In other embodiments, the menu is presented in alphabetical order with the most likely candidate highlighted. Any type of highlighting can be used including for example, distinctive color, shading, font, inverse video, boldface, italic, or the like.

In one embodiment, categories 102 other than the best candidate are shown in the menu in alphabetical order. In another embodiment, they are presented in an order according to decreasing likelihood of being the intended selection.

In one embodiment, more than one best candidate category 102 is determined and highlighted in the menu 101. The user can select which to use by pointing and clicking or by keyboard commands.

In one embodiment, the category entry field 105 for the transaction is automatically populated with the best candidate category as a default, while the drop-down menu 101 also appears so that a user can select another category 102 if desired. If the user indicates that the best candidate category is acceptable (for example by hitting Enter or Tab), the best candidate category remains in the category entry field 105. If the user makes another selection from the drop-down menu 101, the best candidate category is replaced by the selected category.

In another embodiment, the entry field 105 for the transaction is automatically populated with the best candidate category as a default. The drop-down menu 101 is not initially displayed, but is shown only if the user indicates that he or she wishes to see other choices (for example by hitting a down arrow key on a keyboard). Then, the drop-down menu 101 appears so that a user can select another category 102 if desired.

In another embodiment, the entry field 105 stays blank until the user has selected a category 102 from the drop-down menu 101, while the top-most category in the drop-down menu 101 is initially highlighted so that the user can easily select it by hitting Enter or Tab (or by positioning the cursor over it and clicking the mouse).

In another embodiment, all categories 102 are shown in drop-down menu 101, and all categories 102 that match the user-entered characters 103 are highlighted. The particular category 102 that is identified as the best candidate (based on other information such as transaction type) is shown first among the highlighted categories 102. In one embodiment, a distinctive type of highlight is used to identify this best candidate.

As described above, in any of the variations, the default entry and/or the other candidate categories 102 in the drop-down menu 101 are updated if the user continues to type additional characters 103 (or hits backspace to erase characters). For example, a first best candidate category and drop-down menu 101 may appear when the user has typed in two characters 103; the best candidate category and drop-down menu 101 change to another best candidate category and drop-down menu 101 when the user has typed in three characters. In one embodiment, updates to the best candidate category and/or drop-down menu 101 only take place after a slight pause (for example ½ second) in entry of characters 103; in another embodiment, updates take place immediately upon entry of an additional character 103.

In other embodiments, other available information can be used to determine which candidate category 102 should be selected or shown in entry field 104 and/or drop-down menu 101, and/or how the drop-down menu 101 should be sorted. For example, in one embodiment, more commonly selected categories 102 are given precedence. Thus, the system of the present invention can take into account a user's tendency to select some categories 102 more often than others. The determination as to which categories are used more frequently than others can be made on the basis of overall category usage, or category usage within the current account or account type (for example, different preferences may exist for credit card accounts as opposed to bank accounts), or on the basis of selections previously made with respect to a particular payee (those categories that have previously been used with the payee for the current transaction can be favored over those that have not been used with the current payee, or over those that have been used less frequently with the current payee).

In another embodiment, previously memorized transactions are taken into account. Thus, if a transaction has been memorized for the payee of the current transaction, the category 102 associated with the memorized transaction can be given precedence over other categories.

In another embodiment, the user can specify overrides for category prioritization. For example, the user can indicate that certain categories should always be given precedence over other categories, regardless of other factors such as those discussed above.

In other embodiments, the techniques described herein can be applied to other drop-down menus such as payee/payer name or other descriptive information for transactions. For example, a drop-down menu and/or auto-fill can be provided for the payee/payer field, based on characters the user enters in that field. Candidate payee/payer information can be determined and/or sorted according to other known information about the transaction. If one matching payee/payer has been used more than others for the current account or account type, that payee/payer can be given precedence over other matching payee/payers.

Method

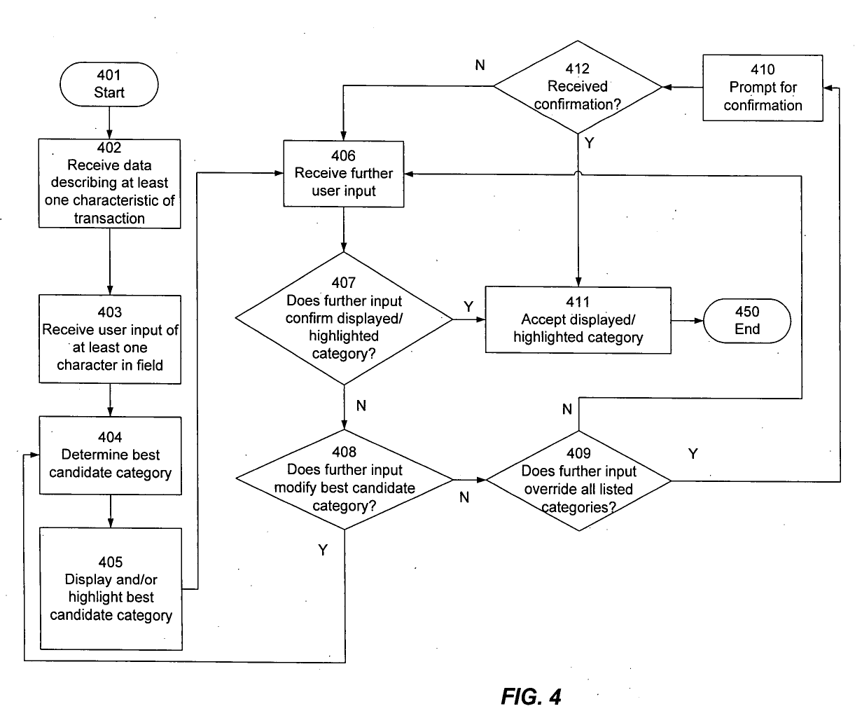

Referring now to FIG. 4, there is shown a flowchart depicting a method for practicing the present invention according to one embodiment.

Data describing at least one characteristic of a transaction 104 is received 402. This data may include, for example, an indication as to whether the transaction 104 is an income or expense transaction. The data can be received by user input, download or other mechanism for receiving transaction information from another source, or by any other means.

The system then receives 403 user input of at least one character 103 in entry field 105. Based on this user input, the system determines 404 the best candidate category 102. It displays and/or highlights 405 this best candidate category 102 according to the techniques described above. For example, the best candidate category 102 can be highlighted within a menu 101 and/or it can be presented in entry field 105.

The system then receives 406 further user input. If the further input confirms 407 the displayed/highlighted category 102 (for example by the user hitting Tab or Enter), the system accepts 411 the displayed/highlighted entry and the method ends 450.

If the further input does not confirm the displayed/highlighted category 102, the system determines whether the further input modifies 408 the selection as to which is the best candidate category 102. If so, the system returns to step 404. If there is no change to the best candidate category 102, the system proceeds to step 409.

The system determines 409 whether the further input overrides all listed categories 102 (in other words, it causes there to be no match with any listed categories 102). If so, it displays the user-entered category 102 as it is entered in entry field 105. Once the user has indicated that he or she is finished with category entry (for example by hitting Tab or Enter), the system prompts 410 the user for confirmation. If it receives confirmation 412, the entered category as displayed in entry field 105 is accepted 411. If the user does not confirm entry of the category, the system returns to step 406 to receive further input.

The method shown in FIG. 4 is one embodiment. As will be understood by one skilled in the art, other variations are possible, including but not limited to those described above.

System Architecture

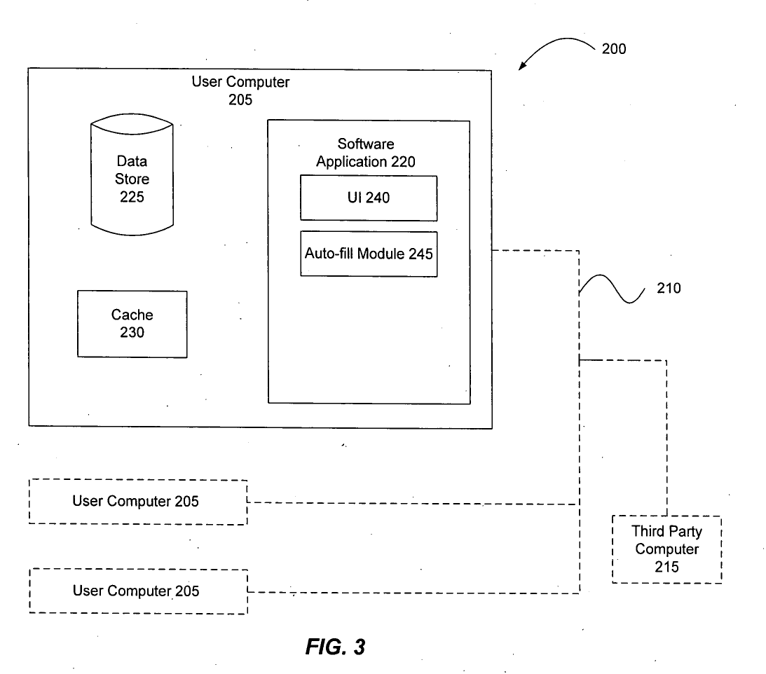

FIG. 3 is a block diagram illustrating the architecture of one embodiment of a system 200 useful for supporting a software application 220 for implementing intelligent auto-fill techniques as described herein. In such a system 200, there is provided at least one user computer 205, which may be a standalone device or may be communicatively coupled to a network 210 and/or one or more third party computers 215, as indicated by dotted lines.

The user computer 205 is of conventional design, and includes a processor, an addressable memory, and other conventional features (not illustrated) such as a display, local memory, input/output ports, and a network interface. In other embodiments one or more of the components of the user computer 205 may be located remotely and accessed via a network, e.g., 210. The network interface and a network communication protocol provide access to a network 210 and other computers, such as other user computers 205 or third party computers 215, along with access to the Internet, via a TCP/IP type connection, or to other network embodiments, such as a LAN, a WAN, a MAN, a wired or wireless network, a private network, a virtual private network, or other networks. In various embodiments the user computer 205 may be implemented on a computer running a Microsoft operating system, Mac OS, various flavors of Linux, UNIX, Palm OS, and/or other operating systems.

The third party computers 215, if present, also may be computer systems, similar to the user computer described above. For example, one embodiment of a third party computer 215 is a financial institution computer system, which provides transactions processing and clearing functionality for user software. The financial institution could be a securities brokerage company, a bank or credit union, a credit card company, or financial institutions. In this embodiment, the user software application 220 described herein may be a financial management software package capable of communicating with the financial institution computer system to access information from pre-existing user accounts (e.g., obtain account balances to determine available funds), and provide payment instructions for making payments to vendors.

The user computer 205 includes a software application 220, data store 225, and data cache 230. The software application 220 includes a number of executable code portions and data files. These include code for creating and supporting a user interface 240 according to one embodiment of the present invention, as well as for implementing categorization functionality. In other embodiments, the software application 220 can also be implemented as a standalone application outside of a financial management software package.

The software application 220 is responsible for orchestrating the processes performed according to the methods of the present invention. The software application 220 includes an auto-fill module 245 according to one embodiment of the present invention.

The auto-fill module 245 enables the system 200 to perform the functions described above. The auto-fill module 245 is one means for generating and displaying drop-down menus for categories and/or other data items, as described above.

The above-described software portions need not be discrete software modules. The software configuration shown is meant only by way of example; other configurations are contemplated by and within the scope of the present invention.

The software application 220 may be provided to the user computer 205 on computer readable media, such as a CD-ROM, diskette, or by electronic communication over the network 210 from one of the third party computers 215 or other distributors of software, for installation and execution thereon. Alternatively, the software application 220, data store 225, and data cache 230 can be hosted on a server computer, and accessed over the network 210 by the user, using for example a browser interface to the software application 220.

The data store 225 may be a relational database or any other type of database that stores the data used by the software application 220, for example account information in the financial management application embodiment referenced above. The data store 225 may be accessible by the software application 220 through the user interface 240. Some data from the data store 225 may be added to the data cache 230 upon initialization of the software application 220. The software application 220 and the data store 225 may be stored and operated on a single computer or on separate computer systems communicating with each other through a network 210.

The data cache 230 is a standard cache of small, fast memory holding recently accessed data. The data cache 230 may include, for example, one or more lists of elements according to one embodiment of the present invention.

One skilled in the art will recognize that the system architecture illustrated in FIG. 4 is exemplary, and that the invention may be practiced and implemented using many other architectures and environments.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is exemplary, and not mandatory; functions performed by a single system component may instead be performed by multiple components, and functions performed by multiple components may instead be performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for automatically presenting a best candidate entry for a field for a transaction, the method comprising:
obtaining a list of candidate entries for the field;
receiving user-entered input for the field, the user-entered input comprising a character string comprising at least one character;
receiving additional descriptive information for the transaction;
responsive to both the character string and the additional descriptive information, identifying at least one best candidate entry from the list of candidate entries;
displaying a menu comprising a plurality of candidate entries including the identified at least one best candidate entry; and
highlighting, within the menu, at least one identified best candidate entry.

2. The method of claim 1, wherein receiving additional descriptive information for the transaction comprises receiving an indication of income or expense transaction type.

3. The method of claim 1, wherein identifying at least one best candidate entry comprises identifying a candidate entry associated with the indicated transaction type.

4. The method of claim 1, wherein the additional descriptive information comprises a transaction amount, and wherein the at least one best candidate entry is identified based on the transaction amount.

5. The method of claim 1, wherein the additional descriptive information comprises descriptive information about a payee, and wherein the at least one best candidate entry is identified based on the descriptive information about the payee.

6. The method of claim 1, wherein the additional descriptive information comprises descriptive information about a payor, and wherein the at least one best candidate entry is identified based on the descriptive information about the payor.

7. The method of claim 1, wherein the at least one best candidate entry is identified based on heuristic analysis of user behavior.

8. The method of claim 7, wherein the heuristic analysis of user behavior comprises an analysis of past spending habits by the user.

9. The method of claim 7, wherein the heuristic analysis of user behavior comprises an analysis of category usage by the user.

10. The method of claim 1, wherein the field comprises a transaction category field, and wherein each candidate entry comprises a transaction category.

11. The method of claim 1, wherein:
identifying at least one best candidate entry comprises identifying exactly one best candidate entry; and
highlighting, within the menu, at least one identified best candidate entry comprises highlighting exactly one best candidate entry.

12. The method of claim 11, further comprising:
presenting, within the field, the best candidate entry.

13. The method of claim 1, further comprising:
receiving user input indicating acceptance of a highlighted candidate entry; and
populating the field with the highlighted candidate entry.

14. The method of claim 1, further comprising:
receiving user input selecting a candidate entry other than a highlighted candidate entry; and
updating the menu to highlight the user-selected candidate entry.

15. The method of claim 1, further comprising:
receiving user input comprising at least one additional character to add to the character string;
responsive to both the character string and the additional descriptive information, identifying at least one best candidate entry from a list;
updating the displayed menu to highlight the at least one identified best candidate entry.

16. The method of claim 1, further comprising:
receiving user input comprising at least one additional character to add to the character string;
responsive to the character string not matching any candidate entries in the list, updating the displayed menu to not highlight any candidate entry.

17. The method of claim 1, wherein receiving additional descriptive information for the transaction comprises receiving user-entered information.

18. The method of claim 1, wherein receiving additional descriptive information for the transaction comprises receiving information from an online source of transaction information.

19. The method of claim 1, wherein each identified best candidate entry matches, at least in part, both the user-entered character string and the additional descriptive information.

20. The method of claim 1, wherein each identified best candidate entry begins with a substring that matches the user-entered character string.

21. The method of claim 1, wherein the transaction comprises a financial transaction.

22. The method of claim 1, wherein the additional descriptive information comprises a transaction amount.

23. The method of claim 1, wherein the additional descriptive information comprises an indication of a pattern of user input.

24. The method of claim 1, wherein the additional descriptive information comprises an indication as to whether the transaction is a memorized transaction.

25. The method of claim 1, wherein the additional descriptive information comprises an indication as to an account associated with the transaction.

26. The method of claim 1, wherein the menu consists only of candidate entries that match, at least in part, the user-entered input.

27. The method of claim 1, further comprising sorting the plurality of candidate entries in the menu so that the identified at least one best candidate entry appears at the top of the menu.

28. A computer-implemented method for automatically populating a field for a transaction, the method comprising:
receiving user-entered input for the field, the user-entered input comprising a character string comprising at least one character;
receiving additional descriptive information for the transaction;
responsive to both the character string and the additional descriptive information, identifying a best candidate entry from a list;
populating the field with the identified best candidate entry.

29. The method of claim 28, wherein receiving additional descriptive information for the transaction comprises receiving an indication of income or expense transaction type.

30. The method of claim 29, wherein identifying a best candidate entry comprises identifying a candidate entry associated with the indicated transaction type.

31. The method of claim 28, wherein the field comprises a transaction category field, and wherein each candidate entry comprises a transaction category.

32. The method of claim 28, further comprising:
receiving user input comprising at least one additional character to add to the character string;
responsive to both the character string and the additional descriptive information, identifying a new best candidate entry from a list; and
populating the field with the new identified best candidate entry.

33. The method of claim 28, further comprising:
receiving user input comprising at least one additional character to add to the character string;
responsive to the character string not matching any candidate entries in the list, updating the field to include only the user input.

34. The method of claim 28, wherein receiving additional descriptive information for the transaction comprises receiving user-entered information.

35. The method of claim 28, wherein receiving additional descriptive information for the transaction comprises receiving information from an online source of transaction information.

36. The method of claim 28, wherein the identified best candidate entry matches, at least in part, both the user-entered character string and the additional descriptive information.

37. The method of claim 28, wherein the identified best candidate entry begins with a substring that matches the user-entered character string.

38. The method of claim 28, wherein the transaction comprises a financial transaction.

39. The method of claim 28, wherein the additional descriptive information comprises a transaction amount.

40. The method of claim 28, wherein the additional descriptive information comprises an indication of a pattern of user input.

41. The method of claim 28, wherein the additional descriptive information comprises an indication as to whether the transaction is a memorized transaction.

42. The method of claim 28, wherein the additional descriptive information comprises an indication as to an account associated with the transaction.

43. A computer-implemented method for selecting a candidate entry for a field for a transaction, the method comprising:
receiving user-entered input for the transaction, the user-entered input comprising a character string comprising at least one character:
receiving additional descriptive information for the transaction;
identifying at least two candidate entries containing the character string; and
identifying a default among the candidate entries, based on the additional descriptive information; and
tentatively populating the field using the default candidate entry.

44. The computer-implemented method of claim 43, further comprising:
displaying a list of candidate entries other than the default candidate entry.

45. The computer-implemented method of claim 44, further comprising:
responsive to user selection of a candidate entry from the list, replacing the default candidate entry with the user-selected candidate entry.

46. A computer-implemented method for presenting a list of candidate entries for a field for a transaction, the method comprising:
receiving user-entered input for the transaction, the user-entered input comprising a character string comprising at least one character:
receiving additional descriptive information for the transaction;
identifying at least two candidate entries containing the character string; and
sorting the identified candidate entries according to the user-entered additional descriptive information; and
displaying a list containing the identified candidate entries.

47. The computer-implemented method of claim 46, further comprising:
receiving user input selecting one of the displayed candidate entries; and
populating the field for the transaction using the selected entry.

48. The computer-implemented method of claim 46, further comprising:
receiving user input indicating that a default entry should be used; and
populating the field for the transaction using a topmost entry in the list.

49. The computer-implemented method of claim 46, wherein the additional descriptive information for the transaction comprises a transaction type.

50. A computer program product for automatically presenting a best candidate entry for a field for a transaction, the computer program product comprising:
a computer-readable medium; and
computer program code, encoded on the medium, for:
obtaining a list of candidate entries for the field;
receiving user-entered input for the field, the user-entered input comprising a character string comprising at least one character;
receiving additional descriptive information for the transaction;
responsive to both the character string and the additional descriptive information, identifying at least one best candidate entry from the list of candidate entries;
displaying a menu comprising a plurality of candidate entries including the identified at least one best candidate entry; and
highlighting, within the menu, at least one identified best candidate entry.

51. The computer program product of claim 50, wherein the computer program code for receiving additional descriptive information for the transaction comprises computer program code for receiving an indication of income or expense transaction type.

52. The computer program product of claim 50, wherein the field comprises a transaction category field, and wherein each candidate entry comprises a transaction category.

53. A computer program product for automatically populating a field for a transaction, the computer program product comprising:
a computer-readable medium; and
computer program code, encoded on the medium, for:
receiving user-entered input for the field, the user-entered input comprising a character string comprising at least one character;
receiving additional descriptive information for the transaction;
responsive to both the character string and the additional descriptive information, identifying a best candidate entry from a list;
populating the field with the identified best candidate entry.

54. The computer program product of claim 53, wherein the computer program code for receiving additional descriptive information for the transaction comprises computer program code for receiving an indication of income or expense transaction type.

55. The computer program product of claim 54, wherein the computer program code for identifying a best candidate entry comprises computer program code for identifying a candidate entry associated with the indicated transaction type.

56. The computer program product of claim 53, wherein the field comprises a transaction category field, and wherein each candidate entry comprises a transaction category.

57. A system for automatically presenting a best candidate entry for a field for a transaction, the system comprising:
a user interface module, for obtaining a list of candidate entries for the field;
an input device, for receiving user-entered input for the field, the user-entered input comprising a character string comprising at least one character, and for receiving additional descriptive information for the transaction;
a processor for, responsive to both the character string and the additional descriptive information, identifying at least one best candidate entry from the list of candidate entries; and
an output device, for displaying a menu comprising a plurality of candidate entries including the identified at least one best candidate entry, and for highlighting, within the menu, at least one identified best candidate entry.

58. The system of claim 57, wherein the additional descriptive information for the transaction comprises an indication of income or expense transaction type.

59. The system of claim 57, wherein the field comprises a transaction category field, and wherein each candidate entry comprises a transaction category.

60. A system for automatically populating a field for a transaction, the system comprising:
an input device, for receiving user-entered input for the field, the user-entered input comprising a character string comprising at least one character, and for receiving additional descriptive information for the transaction;
a processor for, responsive to both the character string and the additional descriptive information, identifying a best candidate entry from a list;
an output device, for populating the field with the identified best candidate entry and for displaying the populated field.

61. The system of claim 60, wherein the additional descriptive information for the transaction comprises an indication of income or expense transaction type.

62. The system of claim 61, wherein the processor identifies a best candidate entry by identifying a candidate entry associated with the indicated transaction type.

63. The system of claim 60, wherein the field comprises a transaction category field, and wherein each candidate entry comprises a transaction category.
